(19) United States
(12) Patent Application Publication
(10) Pub. No.: US 2014/0160360 A1
(43) Pub. Date: Jun. 12, 2014

(54) REMOTE CONTROL DEVICE AND METHOD FOR CHANGING TV CHANNELS OF TELEVISION

(71) Applicant: HON HAI PRECISION INDUSTRY CO., LTD., New Taipei (TW)

(72) Inventors: CHIA-CHING HSU, New Taipei (TW); CHUN-KAI WU, New Taipei (TW); I-CHIN HUNG, New Taipei (TW); CHUNG-I LEE, New Taipei (TW)

(73) Assignee: HON HAI PRECISION INDUSTRY CO., LTD., New Taipei (TW)

(21) Appl. No.: 13/729,239

(22) Filed: Dec. 28, 2012

(30) Foreign Application Priority Data
Dec. 11, 2012 (TW) 101146489

(51) Int. Cl. H04N 5/44

(52) U.S. Cl. 348/734

(57) ABSTRACT

In a method for changing TV channels of a television using a remote control device, the method locates a location of the remote control device, obtains channels of TV stations from a database according to a relation between the location of the remote control device and the channels of the TV stations. The method displays the channels of the TV stations on a display screen of the remote control device, selects a channel from the channels of TV stations displayed on the display screen, and sends a control signal to control the television to change to a channel according to the selected channel.

### BACKGROUND

1. Technical Field

Embodiments of the present disclosure relate to electronic devices and methods for control televisions, and more particularly to a remote control device and a method for changing TV channels of a television.

2. Description of related art

Cable television stations may be on different channels in different locations because there is not a unified frequency among various cable television system, which can be inconvenient. For example, in Taiwan, the channel for CNN in the Dafeng cable TV system is CH104, and the channel for CNN in the Chun Chien cable TV system is CH06.

### BRIEF DESCRIPTION OF THE DRAWINGS

FIG. 1 is a block diagram of one embodiment of a remote control device including a TV channel changing system.

FIG. 2 is a block diagram of one embodiment of function modules of the TV channel changing system in FIG. 1.

FIG. 3 is a flowchart of one embodiment of a method for changing TV channels.

### DETAILED DESCRIPTION

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable storage medium or other storage device. Some examples of the non-transitory computer-readable storage medium include CDs, DVDs, BLU-RAY, flash memory, and hard disk drives.

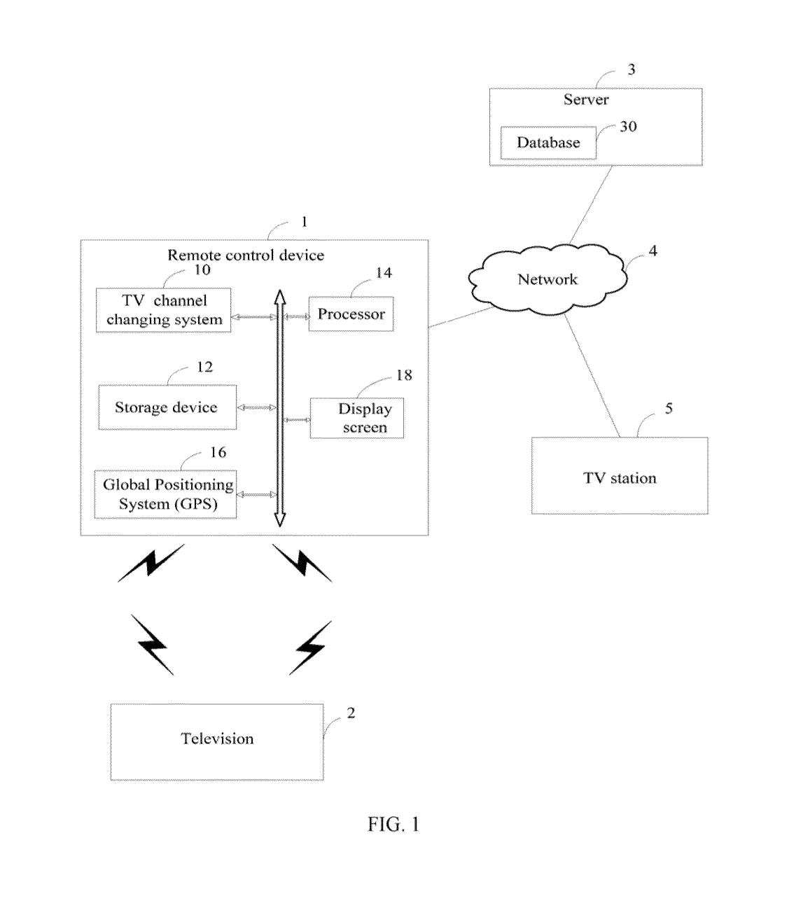

FIG. 1 is a block diagram of one embodiment of a remote control device 1 including a TV channel changing system 120. In the embodiment, the remote control device 1 may be a mobile phone, a personal digital assistant (PDA) or any other handheld devices. The remote control device 1 further includes, but is not limited, a storage device 12, at least one processor 14, a Global Positioning System (GPS) 16, a display screen 18. The remote control device 1 communicates with a television 2 through BLUETOOTH or WIFI, and connects to a server 3 and a plurality of TV stations 5 through a wireless or a wired network 4. FIG. 1 is only one example of the remote control device 1, other examples may include more or fewer components than those shown in the embodiment, or have a different configuration of the various components.

The server 3 includes a database 30 that stores a relation between a location of the remote control device 1 and channels of a plurality of TV stations 5. For example, when the user of the remote control device 1 is in Xinbei, Taiwan, the channel of CNN is H104 and the channel of CCTV is H107. When the user of the remote control device 1 is in Shenzhen, China, the channel of CNN is H108 and the channel of CCTV is H109.

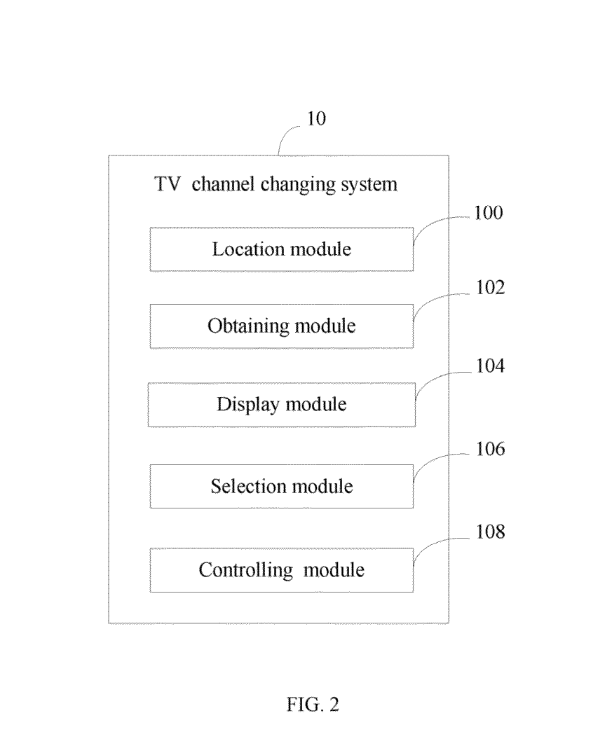

The storage device 12 may include any type(s) of non-transitory computer-readable storage medium, such as a hard disk drive, a compact disc, a digital video disc, or a tape drive. In the embodiment, the storage device 12 stores the TV channel changing system 120 including a plurality of function modules (see FIG. 2 below) in form of one or more programs.

The at least one processor 14 may include a processor unit, a microprocessor, an application-specific integrated circuit, and a field programmable gate array, for example.

The GPS 16 is used to locate a location of the remote control device 1 and may be substituted by a Beidou satellite navigation system or a Galileo navigation satellite system (GNSS) in the embodiment. The display screen 18 of the remote control device 1 is used to display the channels of the plurality of TV stations 5, for example the display screen 18 may display the channels of the plurality of TV stations 5 by displaying the names or logos of the plurality of TV stations 5 and the corresponding channels of the plurality of TV stations 5.

In one embodiment, the TV channel changing system 120 includes a plurality of function modules (see FIG. 2 below), which include computerized codes or instructions that can be stored in the storage device 12 and executed by the at least one processor 14 to provide a method for changing TV channels.

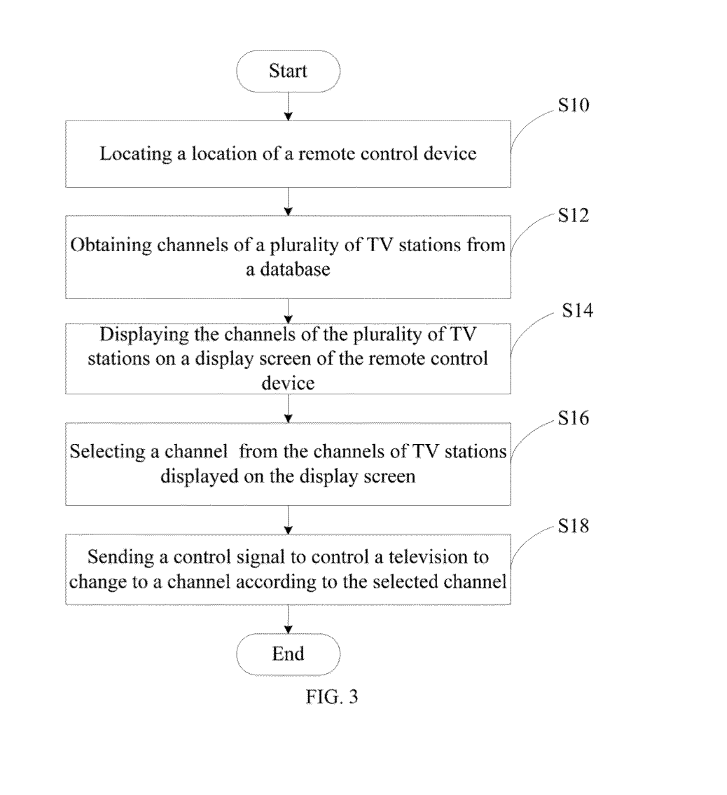

FIG. 2 is a block diagram of one embodiment of the TV channel changing system 120 included in the remote control device 1. In one embodiment, the TV channel changing system 120 may include a location module 100, an obtaining module 102, a display module 104, a selection module 106 and a control module 108. The modules may comprise computerized codes in the form of one or more programs that are stored in the storage device 12 and executed by the at least one processor 14 to provide functions for implementing the modules. The functions of the function modules 100-108 are illustrated in FIG. 3 and described below.

FIG. 3 illustrates a flowchart of one embodiment of a method for changing TV channels of the television 2. Depending on the embodiment, additional steps may be added, others removed, and the ordering of the steps may be changed.

In step S10, the location module 100 locates the location of the remote control device 1. In the embodiment, the location module 100 may locate the location of the user by locating the location of the remote control device 1 through a Global Positioning System (GPS) 16. In the embodiment, the GPS 16 may be substituted by a Beidou satellite navigation system or a Galileo navigation satellite system (GNSS).

In step S11, the obtaining module 102 obtains the channels of the plurality of TV stations 5 from the database 30 according to the relation between the location of the remote control device 1 and the channels of the plurality of TV stations 5.

In step S12, the display module 104 displays the channels of the plurality of TV stations 5 on the display screen 18 of the remote control device 1. In the embodiment, the display module displays the channels of the plurality of TV stations 5 by displaying the names or logos of the plurality of TV stations 5 and the corresponding channels of the plurality of TV stations 5 on the display screen 18.

In step S13, the selection module 106 selects a channel from the channels of TV stations 5 displayed on the display screen 18.

In step S14, the control module 108 sends a control signal to control the television 2 to change to a channel according to the selected channel. In the embodiment, the control module 108 may send the control signal to the television 2 through WIFI or BLUETOOTH.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A remote control device for changing TV channels of a television, the remote control device comprising:
a display screen;
a storage device, and at least one processor; and
one or more modules that are stored in the storage device and executed by the at least one processor, the one or more modules comprising:
a location module that locates a location of the remote control device;
an obtaining module that obtains channels of a plurality of TV stations from a database according to a relation between the location of the remote control device and the channels of the plurality of TV stations;
a display module that displays the channels of the plurality of TV stations on the display screen of the remote control device;
a selection module that selects a channel from the channels of TV stations displayed on the display screen; and
a control module that sends a control signal to control the television to change to a channel according to the selected channel.

2. The remote control device according to claim 1, wherein the location module locates the location of the remote control device through a Global Positioning System (GPS).

3. The electronic device according to claim 1, wherein the display module displays the channels of the plurality of TV stations by displaying names or logos of the plurality of TV stations and the channels of the plurality of TV stations on the display screen.

4. The electronic device according to claim 1, wherein the control module sends the control signal to the television through WIFI or BLUETOOTH.

5. A method for changing TV channels of a television using a remote control device, the method comprising:
locating a location of a remote control device;
obtaining channels of a plurality of TV stations from a database according to a relation between the location of the remote control device and the channels of the plurality of TV stations;
displaying the channels of the plurality of TV stations on a display screen of the remote control device;
selecting a channel from the channels of TV stations displayed on the display screen; and
sending a control signal to control the television to change to a channel according to the selected channel.

6. The method according to claim 5, further comprising:
locating the location of the remote control device through a Global Positioning System (GPS).

7. The method according to claim 5, further comprising:
displaying the channels of the plurality of TV stations by displaying names or logos of the plurality of TV stations and the channels of the plurality of TV stations on the display screen.

8. The method according to claim 5, wherein the control signal is sent to the television through WIFI or BLUETOOTH.

9. A non-transitory computer-readable storage medium having stored thereon instructions, when executed by a processor of a remote control device, causes the processor to perform a method for changing TV channels of a television, the method comprising:
locating a location of a remote control device;
obtaining channels of a plurality of TV stations from a database according to a relation between the location of the remote control device and the channels of the plurality of TV stations;
displaying the channels of the plurality of TV stations on a display screen of the remote control device;
selecting a channel from the channels of TV stations displayed on the display screen; and
sending a control signal to control the television to change to a channel according to the selected channel.

10. The storage medium according to claim 9, wherein the method further comprises:
locating the location of the remote control device through a Global Positioning System (GPS).

11. The storage medium according to claim 9, the method further comprises:
displaying the channels of the plurality of TV stations by displaying names or logos of the plurality of TV stations and the channels of the plurality of TV stations on the display screen.

12. The storage medium according to claim 9, wherein the control signal is sent to the television through WIFI or BLUETOOTH.
